(19) United States
(12) Patent Application Publication
(10) Pub. No.: US 2014/0372203 A1
(43) Pub. Date: Dec. 18, 2014

(54) QUALITY-WEIGHTED SECOND-PRICE AUCTIONS FOR ADVERTISEMENTS

(71) Applicant: MICROSOFT CORPORATION, Redmond, WA (US)

(72) Inventors: NATHANIEL EDWARD POWELL, Redmond, WA (US); PATRICK RICHARD LLOYD JORDAN, Mountain View, CA (US); SUSAN C. ATHEY, Palo Alto, CA (US)

(21) Appl. No.: 13/917,939

(22) Filed: Jun. 14, 2013

(51) Int. Cl. G06Q 30/02

(52) U.S. Cl. CPC G06Q 30/0243; G06Q 30/0246; G06Q 30/0275
USPC 705/14.42

(57) ABSTRACT

Methods, computer systems, and computer-storage media are provided for utilizing a quality-weighted generalized second-price auction to rank, price, and allocate advertisements for presentation on a results page. Advertisements responsive to a search query are identified, and a rank score is determined for each of the advertisements. The rank score is determined based on a quality score associated with each of the advertisements as well as a bid price for each of the advertisements. The satisfied click-through-rate for an advertisement is used as a proxy metric for the quality score. The quality score is further used to determine the cost-per-click of the advertisement. Certain quality metrics may also be utilized to determine the number of advertisements that should be presented on the results page in order to maximize publisher revenue and minimize user cost.

### BACKGROUND

Generalized second-price auctions are one way to select advertisements for presentation on a results page. The advertisements are generally selected based on their rank score. Traditionally, the rank score for each advertisement is the bid price for the advertisement multiplied by its click-through-rate or by its estimated clickability. In turn, clickability is defined as the number of estimated clicks the advertisement would receive if it were placed in the top position on the results page. Clickability and/or click-through-rates have traditionally been considered indicators of the quality of a given advertisement. In a generalized second-price auction, the bids are then ranked by their rank scores, and the cost-per-click for each advertisement is set as the minimum bid the advertiser could have placed to maintain its position in the ranking. Generalized second-price auctions that use click-through-rates and/or clickability to generate rank scores are sometimes known as “click-weighted second-price auctions.”

Click-weighted second-price auctions can lead to advertiser obfuscation. Advertiser obfuscation occurs when advertisers attempt to deceive users about whey they can expect when they reach the advertisement's landing page. Because an advertisement's rank score is influenced by how often users select the advertisement, advertisers are incentivized to create an advertisement that encourages users to click on or select the advertisement. Advertisers generally do this by making the advertisement appear to meet a more general need than the advertisement actually meets. Once a user selects an obfuscated advertisement, the user is directed to a landing page that bears little relevance to the user's original intent as evidenced by, for example, a search query. A possible result of using click-weighted second-price auctions to determine ranking and pricing is the presentation of advertisements that consume valuable search result space and offer little benefit to the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, using a quality-weighted generalized second-price auction to rank, price, and determine an appropriate number of advertisements to be presented on a results page in response to, for example, implicit or explicit search queries. Instead of using clickability or click-through-rate as a rank score metric, the present invention utilizes an advertisement's quality score as a rank score metric. The quality score provides an indication of the proportion of users whose needs are met by the advertisement. The present invention utilizes, among other things, the advertisement's satisfied click-through-rate as an approximation of the quality score. A satisfied click is generated every time a user selects the given advertisement and dwells on the landing page for a period of time that is equal to or greater than a predetermined minimum threshold.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for conducting a quality-weighted generalized second-price auction suitable for use in implementing embodiments of the present invention;

FIG. 3 is a flow diagram that illustrates an exemplary method of ranking advertisements that are presented on a results page using a quality-weighted generalized second-price auction in accordance with an embodiment of the present invention;

FIG. 4 is a flow diagram that illustrates an exemplary method of ranking and pricing advertisements that are presented on a results page using a quality-weighted generalized second-price auction in accordance with an embodiment of the present invention; and

FIG. 5 is a flow diagram that illustrates an exemplary method of determining an appropriate number of advertisements to be presented in an advertisement block on a results page using a quality-weighted generalized second-price auction in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, using a quality-weighted generalized second-price auction to rank, price, and allocate a set of advertisements presented on a results page. Advertisements responsive to a search query are identified, and a rank score is determined for each of the advertisements. The rank score is determined based on a quality score associated with each of the advertisements as well as a bid price for each of the advertisements. The satisfied click-through-rate for an advertisement is used as a proxy metric for the quality score. The quality score is further used to determine the cost-per-click (CPC) of the advertisement. Certain quality metrics may also be utilized to determine the number of advertisements that will be presented in a given advertisement block on the results page in order to maximize publisher revenue and minimize user cost.

Accordingly, in one embodiment, the present invention is directed to one or more computer-storage media having computer-executable instructions embodied thereon that, when executed, perform a method of ranking advertisements that are presented on a results page using a quality-weighting generalized second-price auction. The method comprises identifying a set of advertisements that is relevant to a search query and determining a rank score for each advertisement in the set of advertisements based on a quality score of the each advertisement and a bid price of the each advertisement. The quality score is based in part on a satisfied click-through-rate for the each advertisement. A plurality of top-ranked advertisements of the set of advertisements is communicated to a publisher who presents in ranked order the plurality of top-ranked advertisements on the results page.

In another embodiment, the present invention is directed to one or more computer-storage media having computer-executable instructions embodied thereon that, when executed, perform a method of ranking and pricing advertisements that are presented on a results page using quality weighting in a generalized second-price auction. The method comprises identifying a set of advertisements that is relevant to a search query and determining a rank score for each advertisement in the set of advertisements. The rank score is determined based on a quality score of the each advertisement and a bid price of the each advertisement, and the quality score is based in part on a satisfied click-through-rate for the each advertisement. The set of advertisements is ranked based on the rank scores, and a CPC is determined for the each advertisement in the set of advertisements. For a given advertisement in the set of advertisements, when the given advertisement is an exact match to the search query, the CPC is determined based on a quality score of an advertisement ranked directly below the given advertisement, a bid price of the advertisement ranked directly below the given advertisement, and a quality score of the given advertisement. When the given advertisement is a broad match to the search query, the CPC is determined based on a probability that an advertisement ranked directly below the given advertisement will receive a click, a probability that a user's need is met given there is a click on the advertisement ranked directly below the given advertisement, a bid price of the advertisement ranked directly below the given advertisement, and a probability that the given advertisement will receive a click.

In yet another embodiment, the present invention is directed to one or more computer-storage media having computer-executable instructions embodied thereon that, when executed, perform a method of determining a number of advertisements to be presented in an advertisement block on a results page in a quality-weighted generalized second-price auction. The method comprises defining an expected satisfied revenue when n top-ranked advertisements are presented in the advertisement block on the results page and defining a user cost when n top-ranked advertisements are presented in the advertisement block on the results page. An objective function is defined that generates a single solution based on the expected satisfied revenue and the user cost for each n top-ranked advertisements. For each value of n, the objective function is used to generate a solution. The n value associated with the solution having the highest value is determined. The n value associated with the solution having the highest value is equal to the number of advertisements to be presented in the advertisement block on the results page such that expect satisfied revenue is maximized and user cost is minimized. The determined number of advertisements is communicated to a publisher who presents the determined number of advertisements on the results page.

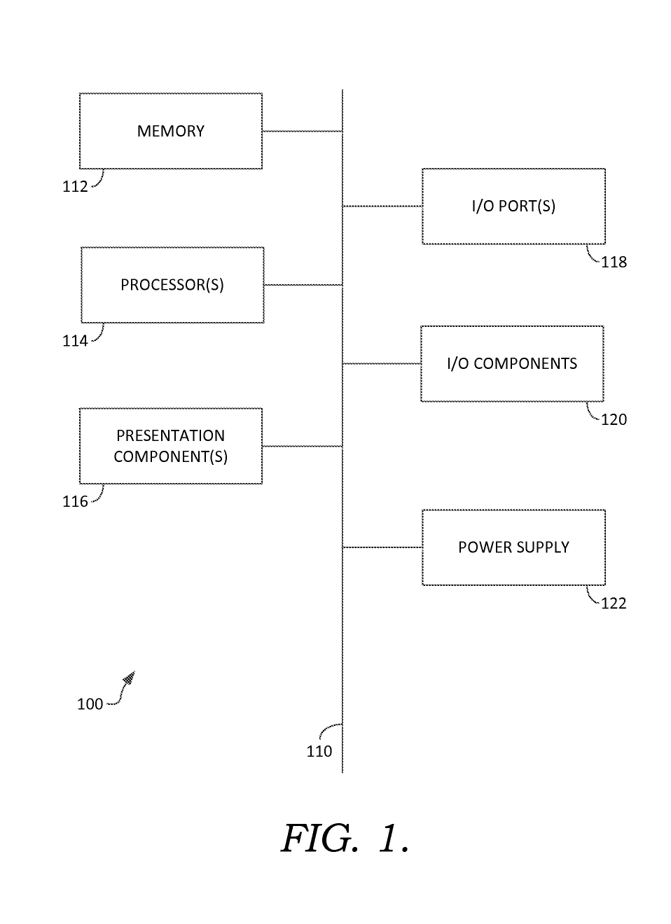

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, camera, joystick, game pad, satellite dish, scanner, printer, wireless device, and the like.

Furthermore, although the term “server” is often used herein, it will be recognized that this term may also encompass a search service, an advertisement server, a Web browser, a cloud server, a set of one or more processes distributed on one or more computers, one or more stand-alone storage devices, a set of one or more other computing or storage devices, a combination of one or more of the above, and the like.

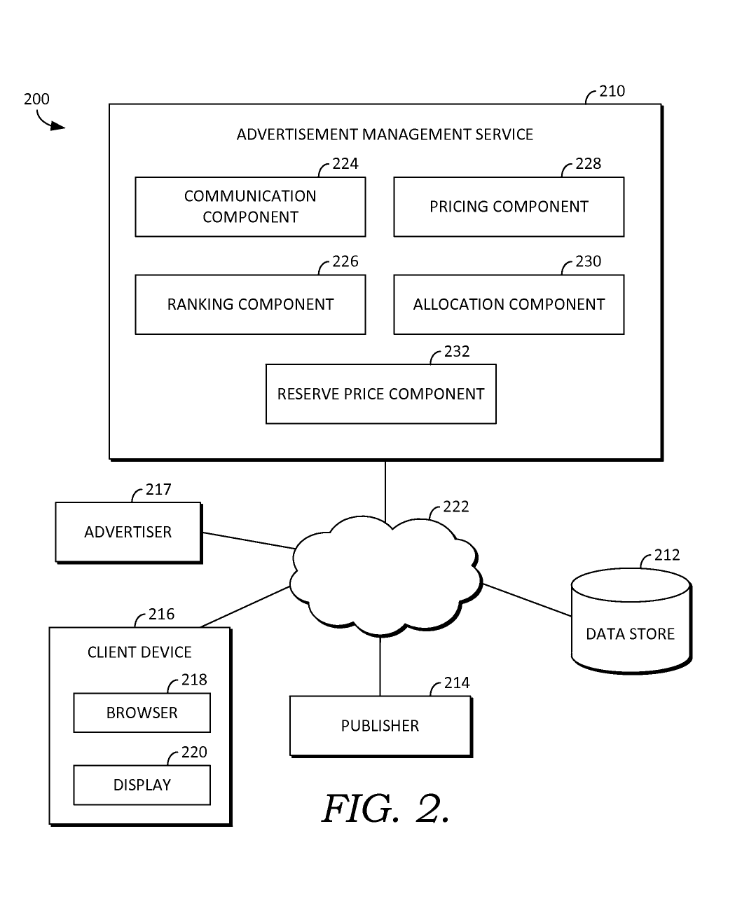

Referring now to FIG. 2, a block diagram is provided illustrating an exemplary computing system 200 in which embodiments of the present invention may be employed. Generally, the computing system 200 illustrates an environment in which a quality-weighted generalized second-price auction is carried out in real time in order to rank, price, and allocate advertisements that are presented on a results page, such as a search engine results page.

Among other components not shown, the computing system 200 generally includes an advertisement management service 210, a data store 212, a publisher 214, a client device 216, and an advertiser 217 all in communication with one another via a network 222. The network 222 may include, without limitation, one or more local area networks (LANs) and/or wide area networks (WANs). Such networking environments are commonplace in offices, enterprise-wide computer networks, intranets and the Internet. Accordingly, the network 222 is not further described herein.

It should be understood that any number of advertisement management services, publishers, advertisers, and client computing devices may be employed in the computing system 200 within the scope of embodiments of the present invention. Each may comprise a single device/interface or multiple devices/interfaces cooperating in a distributed environment. For instance, the advertisement management service 210 may comprise multiple devices and/or modules arranged in a distributed environment that collectively provide the functionality of the advertisement management service 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client device 216, as an Internet-based service, or as a module inside the advertisement management service 210. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of advertisement management services, or client computing devices. By way of example only, the advertisement management service 210 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The publisher 214 may comprise any service and/or company that publishes or delivers advertisements via the Web. Such companies are numerous but representative examples may include public search engines such as, for example, Bing®, paid search services, social network sites such as Facebook® or Twitter®, social news sites such as Reddit®, social photo and video sharing sites such as YouTube®, social bookmarking sites such as Pinterest® and other third-party application sites, blogs, email marketing companies, and the like. The advertisements may be published in association with results, such as search results. Although only one publisher is illustrated in FIG. 2, it is contemplated that the computer system 200 may encompass any number of publishers.

The advertiser 217 may comprise a company, entity, and/or individual that sells or promotes goods and/or services using online advertising. As such, the advertiser (or a third-party company working in collaboration with the advertiser) may develop online advertisements for specified products or services, consumer buying segments, times, and the like. The advertisements may be in the form of graphical advertisements, text-only advertisements, image advertisements, audio and/or video advertisements, and the like. The advertisements may include embedded links that, when selected, direct a user to pages on the advertisers' websites. Although only one advertiser is illustrated in FIG. 2, it is contemplated that the computer system 200 may encompass any number of advertisers.

The client computing device 216 may include any type of computing device, such as the computing device 100 described with reference to FIG. 1, for example. Generally, the client computing device 216 includes a browser 218 and a display 220. The browser 218, among other things, is configured to render search home pages (or other online landing pages), and render results pages in association with the display 220 of the client computing device 216. As used throughout this application, the term “results page” is meant to encompass Web pages such as search engine results pages, and result pages associated with search applications, either standalone or embedded in other applications (e.g., Xbox®, Microsoft® Office, and the like). Applications such as these may present search results as well as advertisements in association with a Web page or may present search results and advertisements on other types of pages such as dialog boxes.

The browser 218 is further configured to receive user input of requests for various web pages (including search engine home pages), receive user inputted search queries (generally inputted via a user interface presented on the display 220 and permitting alpha-numeric and/or textual input, voice input, and/or gesture input into a designated search box), and to receive content for presentation on the display 220, for instance, from the advertisement management service 210. The browser 218 may be any suitable type of Web browser such as Internet Explorer®, Firefox®, Chrome®, Safari®, or other type of software configured to enable submission of search queries as disclosed herein. It should be noted that the functionality described herein as being performed by the browser 218 may be performed by any other application capable of rendering Web content. Any and all such variations, and any combination thereof, are contemplated to be within the scope of embodiments of the present invention. The display 220 is configured to present various content including, without limitation, browser pages, search engine home and result pages, and/or third-party application pages. In embodiments, the display 220 is further configured to enable touch inputs, auditory inputs, and/or gesture inputs from a user.

As illustrated, the advertisement management service 210 includes a communication component 224, a ranking component 226, a pricing component 228, an allocation component 230, and a reserve price component 232. In some embodiments, one or more of the components 224, 226, 228, 230, and 232 may be implemented as stand-alone applications. In other embodiments, one or more of the components 224, 226, 228, 230, and 232 may be integrated directly into the operating system of a computing device such as the computing device 100 of FIG. 1 or the client device 216. It will be understood that the components 224, 226, 228, 230, and 232 illustrated in FIG. 2 are exemplary in nature and in number and should not be construed as limiting. Any number of components may be employed to achieve the desired functionality within the scope of embodiments hereof.

The illustrated advertisement management service 210 also has access to the data store 212. The data store 212 is configured to store information for use by, for example, the advertisement management service 210. The information stored in association with the data store 212 is configured to be searchable for one or more items of information stored in association therewith. The information stored in association with the data store 212 may comprise general information used by the advertisement management service 210.

For instance, the data store 212 may store advertisement files containing advertisements and other information. Information associated with an advertisement file may include the identity of a user who created the advertisement, keywords associated with the advertisement, content categories associated with the advertisement, information concerning geospatial and/or temporal requirements associated with publication of the advertisement, publishers to whom the advertisement was communicated, how often the advertisement has been communicated to publishers, and the like.

Information associated with the advertisement file also includes an engagement history with the advertisement. The engagement history includes how often users (in general, or a single user in particular) have selected or “clicked” on the advertisement (e.g., the click-through-rate), the proportion of users who access a secure page after selecting the advertisement (based on, for example, an analysis of the uniform resource locator (URL) stream after the advertisement is selected), the proportion of users who return to the current search session after selecting the advertisement, and, if known, conversions associated with the advertisement. As used throughout the specification, the term “click” is meant to be construed broadly. A click refers to a selection of an item using, for example, a pointing device such as a mouse, a gesture, a voice command, and the like.

Continuing, the engagement history also includes the satisfied click-through-rate associated with the advertisement. As defined above, a satisfied click is generated every time a user selects the advertisement and dwells on the advertisement's landing page(s) for a period of time that is equal to or greater than a predetermined minimum threshold. Exemplary minimum thresholds include 20 seconds or greater, 30 seconds or greater, and the like. Satisfied click-through-rates give an indication of the proportion of users whose needs were met after selecting the advertisement and can be used as an approximation of the quality of the advertisement. For instance, an advertisement that is designed solely to entice users to select the advertisement in order to increase the advertisement's click-through-rate may actually be of poor quality as shown by the users quickly navigating back to the results page after viewing the advertisement's landing page. However, a high-quality advertisement is one that meets the users' needs as shown by the users spending a predetermined amount of time on the advertisement's landing page(s).

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the advertisement management service 210, the client device 216, and/or any combination thereof.

The communication component 224 of the advertisement management service 210 is is configured to receive and respond to requests and/or communications from components associated with client computing devices, such as the client computing device 216. Additionally, the communication component 224 is configured to receive and respond to requests from the publisher 214 for advertisements that are relevant to, for example, an explicit or an implicit search query. The request received from the publisher 214 may specify a maximum number of advertisements that the publisher 214 can accommodate on a results page. Additionally, the request from the publisher 214 may include information concerning the query, information about the search results that are responsive to the query, and the like. The communication component 224 uses this information to identify advertisements that are relevant to the search query; the advertisements may be stored in association with the data store 212 or the advertisements may be retrieved from the advertiser 217.

As will be explained in greater depth below, after the identified advertisements have been ranked, priced, and allocated, the communication component 224 is further configured to communicate a determined number of the top-ranked advertisements to the publisher 214. The publisher 214 combines the top-ranked advertisements with search results and presents both of these on a results page.

The communication component 224 is also configured to communicate with the advertiser 217. The communication component 224 may communicate with the advertiser 217 to retrieve advertisements that are relevant to a particular query. As well, the communication component 224 receives bids from the advertiser 217. The bidding process is triggered when the advertisement management service 210 receives a request from the publisher 214 for advertisements. The bids comprise the maximum amount the advertiser 217 is willing to pay for a given advertisement spot on the results page. The advertiser 217 may take into account keywords, geographic considerations, the quality of its advertisements, publisher characteristics, temporal considerations, content categories, and the like when determining the amount it is willing to bid.

The ranking component 226 of the advertisement management service 210 is configured to rank the advertisements identified as relevant by the communication component 224. The ranking component 226 ranks the advertisements by generating a rank score for each of the advertisements and ordering the advertisements based their respective rank scores. An advertisement having a greater rank score is ordered before an advertisement having a lesser rank score. The rank score is generated using the following formula:

Rank Scoreᵢ=qᵢbᵢ (Formula 1)

The Rank Score, is the rank score of the i^{th} advertisement, qᵢ is the quality score of the i^{th} advertisement, and b, is the bid price of the advertisement. The quality score, q, of an advertisement ranges from 0 to 1. The quality score is 1 if the advertisement and its associated landing page meet 100% of the user's need, and 0 if the advertisement and its associated landing page do not meet the user's needs. The present invention utilizes one or more proxy metrics that provide an approximation of the quality score. One of the proxy metrics already discussed is the satisfied click-through-rate of the advertisement. Other proxy metrics for quality include conversion rates associated with the selected advertisement (if known), the proportion of users who did not return to the search session within a predetermined amount of time after selecting the advertisement (i.e., whether the selection of the advertisement constituted a “last click”), and the proportion of users who access a secure page after selecting the advertisement. A secure page may be defined as a Web page where a user enters secure payment information in order to effectuate a purchase of the advertiser's product and/or service. Any and all of these proxy metrics may be considered when determining the quality score for a given advertisement.

Once the rank scores have been determined for each advertisement by the ranking component 226 and the advertisements have been ranked based on their rank scores, the pricing component 228 determines a cost-per-click (CPC) for each of the advertisements. The CPC is the price the advertiser 217 pays every time the advertisement is published on a results page and selected by a user. The pricing component 228 determines the CPC in different ways depending on whether the given advertisement is an exact match to the search query or a broad match to the search query. An exact match advertisement is triggered only when a user searches for the exact phrase of the advertisement's keyword(s) or close variations of the exact phrase of the advertisement's keyword(s). A broad match advertisement is triggered if a search query contains the advertisement's keyword(s) in any order, possibly along with other terms.

For an exact match advertisement, the pricing component 228 determines the CPC using the following formula:

$${CPC}_{i} = \frac{{q}_{i + 1} {b}_{i + 1}}{{q}_{i}} \qquad ( Formula 2 )$$

Where CPCᵢ is the cost-per-click of the exact match advertisement, qᵢ₊₁ is the quality score of the advertisement ranked directly below the exact match advertisement, bᵢ₊₁ is the bid price of the advertisement ranked directly below the exact match advertisement, and qᵢ is the quality score of the exact match advertisement. As can be seen from the CPC formula for exact match advertisements, the advertiser 217 will pay more if the advertisement ranked below the exact match advertisement is of higher quality as compared to the exact match advertisement. Conversely, the higher the quality of the exact match advertisement, the less the advertiser 217 will have to pay. Using this type of formula to determine CPC incentivizes advertisers to produce high-quality advertisements that fulfill users' needs.

For a broad match advertisement, the pricing component 228 determines the CPC by utilizing the following formula:

$$CPCi = \frac{p ( {c}_{i + 1} ) p ( {n}_{i + 1} \vert {c}_{i + 1} ) {b}_{i + 1}}{p ( {c}_{i} )} \qquad ( Formula 3 )$$

Where CPCᵢ is the cost-per-click for the broad match advertisement, p(cᵢ₊₁) is the probability of a click on the advertisement that is ranked directly below the broad match advertisement, p(nᵢ₊₁|cᵢ₊₁) is the probability that the user's need is met given there is the click on the advertisement that is ranked directly below the broad match advertisement, bᵢ₊₁ is the bid price of the advertisement that is ranked directly below the broad match advertisement, and p(cᵢ) is the probability that the broad match advertisement will receive a click.

Once the advertisements have been ranked and priced, the allocation component 230 utilizes various quality metrics and objective functions to determine how many advertisements will be presented in each of the various advertisement blocks on the results page to maximize publisher revenue while minimizing user cost. The advertisement blocks may include, for example, a mainline block directly above the search results, a sidebar block on the right-hand side of the results page, and a bottom block positioned below the search results. If the cost to the user in presenting an additional advertisement in a given advertisement block is greater than the benefit the user will receive from the advertisement, the publisher will likely refrain from including the advertisement in the advertisement block.

A general form of an objective function that describes the relationship between publisher revenue and user cost in terms of the number of advertisements presented in a given advertisement block is provided below:

F′(n)=E(Rₙ)−αU(n) (Formula 4)

Where n is a number of top-ranked advertisements to be presented in the given advertisement block, F′(n) is an objective function that generates a single solution for each value of n, E(Rₙ) is the expected satisfied revenue (the revenue obtained when the user clicks on the advertisement block and has a dwell time greater than 20 or 30 seconds), α is a calibration constant, and U(n) is the user cost incurred when the top n advertisements are presented in the advertisement block.

The allocation component 230 calculates this function (Formula 4) for each of the possible number of advertisements, n, to be presented in the advertisement block. The number of advertisements in the given advertisement block may vary between zero up to, for example, five advertisements. The allocation component 230 then selects the value of n that produced the highest-valued solution of the objective function. This value of n will lead to a maximization of satisfied revenue while keeping user cost to a minimum.

The allocation component 230 may utilize a number of different metrics to model the cost to the user, U(n). In one embodiment, the user cost is directly proportional to the amount of screen real estate taken up by the top n advertisements in the given advertisement block. In other words:

U(n)=Sₙ (Formula 5)

Where Sₙ is the vertical space consumed by the top n advertisements in the given advertisement block on the results page. The user cost may be further adjusted by taking into account the “win rate” of the advertisement block as compared to the rest of the results page. The win rate may be defined as the probability that the advertisement block will receive a satisfied click versus the probability of a satisfied click somewhere on the entire results page. Taking into account the win rate, the user cost may now be defined by the formula:

$$U ( n ) = \frac{{S}_{n}}{{W}_{n}} \qquad ( Formula 6 )$$

Where Sₙ is the vertical space consumed by the top n advertisements in the given advertisement block on the results page, and Wₙ is the win rate of the advertisement block when the top n advertisements are presented. As seen from this formula, as the win rate for the advertisement block increases, the user cost decreases. Using the definition of win rate as given above, Wₙ may be rewritten as:

$${W}_{n} = \frac{P ( C \vert n )}{P ( {C}_{W} \vert n )} \qquad ( Formula 7 )$$

Where P(C|n) is the probability of a satisfied click somewhere in the advertisement block given n top-ranked advertisements in the advertisement block, and P(C_{w}|n) is the probability of a satisfied click somewhere on the entire results page (e.g., advertisements, search results, etc.) given n top-ranked advertisements in the advertisement block. P(C|n), in turn, can be calculated as:

P(C|n)=Σᵢ₌₁ⁿP(Cᵢ|n) (Formula 8)

Where the probability of a satisfied click on each advertisement, i, in the advertisement block is summed to generate the overall probability of a satisfied click somewhere in the advertisement block given n top-ranked advertisements in the block.

Returning to Formula 4, the expected satisfied revenue for the given advertisement block may be defined using the formula:

E(Rₙ)=Σᵢ₌₁ⁿ(Cᵢ|n)CPCᵢ (Formula 9)

Where P(Cᵢ|n) is the probability of a satisfied click on the i^{th} advertisement in the given advertisement block when the top n advertisements are presented in the advertisement block, and CPCᵢ is the cost-per-click of the i^{th} advertisement in the given advertisement block. The CPCᵢ is calculated using either Formula 2 or Formula 3 depending on whether the i^{th} advertisement is an exact match advertisement or a broad match advertisement.

Substituting Formulas 6, 7 and 9 into Formula 4, the allocation component 230 utilizes the following objective function in expanded form to determine how many top-ranked advertisements, n, should be presented in the given advertisement block:

$${F}^{′} ( n ) = {\sum }_{i = 1}^{n} P ( {C}_{i} \vert n ) {CPC}_{i} - α {S}_{n} \frac{P ( {C}_{W} \vert n )}{P ( C \vert n )} \qquad ( Formula 10 )$$

Since the reserve price for the last advertisement in the given block has not yet been set, an adjustment is made to Formula 10 to ensure that the function generates the maximum value possible when presenting the top n advertisements. Since the user cost is fixed and is not affected by the final advertisement pricing, the expected satisfied revenue side of the function is maximized by setting the CPC for the bottom-most advertisement in the block to be its bid price. This is shown by the following formula:

$${F}^{′} ( n ) = {\sum }_{i = 1}^{n - 1} P ( {C}_{i} \vert n ) {CPC}_{i} + P ( {C}_{n} \vert n ) {Bid}_{n} - α {S}_{n} \frac{P ( {C}_{W} \vert n )}{P ( C \vert n )} \qquad ( Formula 11 )$$

Where P (Cₙ|n) is the probability of a click on the lowest-ranked advertisement in the advertisement block, and Bidₙ is the bid price for the bottom-most advertisement in the block. Bidₙ, however, is not the final reserve price for the lowest-ranked advertisement. Determination of the final reserve price will be explained in greater depth below.

As explained above, the allocation component 230 substitutes various values of n in Formula 11 in order to determine the value of n that yields the highest-valued solution of the formula. This value of n is equivalent to the number of top-ranked advertisements to be presented in the given advertisement block on the results page in order to maximize satisfied revenue and minimize user cost. The communication component 224 of the advertisement management service 210 then communicates the determined number of advertisements to the publisher 214 who subsequently publishes the advertisements on the results page.

The reserve price component 232 of the advertisement management service 210 is configured to determine the minimum reserve price for the lowest-ranked advertisement in the given advertisement block. Traditionally, minimum reserve prices have been fixed by the publisher and range around five cents. However, the reserve price component 232 is configured to utilize the objective function (Formula 11) set forth above to determine an alternative minimum reserve price that reflects user cost. The minimum reserve price is set to the minimum price needed for the objective function solution for the number of top n advertisements selected to be equal to the objective function solution of the next-best option with k advertisements. This is shown by the formula:

F′(n)=F′(k) (Formula 12)

Because the next-best option is maximized, the CPC of the k^{th} advertisement is set to its bid price as shown below in Formula 13:

$${\sum }_{i = 1}^{n - 1} P ( {C}_{i} \vert n ) {CPC}_{i} + P ( {C}_{n} \vert n ) {CPC}_{n} - α U ( n ) = {\sum }_{i = 1}^{k - 1} P ( {C}_{i} \vert k ) {CPC}_{i} + P ( {C}_{k} \vert k ) {Bid}_{k} - α U ( k )$$

Where CPCₙ is the cost-per-click for the lowest-ranked advertisement in the given advertisement block. Solving for CPCₙ yields:

$${CPC}_{n} = \frac{\begin{matrix}{\sum }_{i = 1}^{k - 1} P ( {C}_{i} \vert k ) {CPC}_{i} + P ( {C}_{k} \vert k ) {Bid}_{k} - \\ {\sum }_{i = 1}^{n - 1} P ( {C}_{i} \vert n ) {CPC}_{i} + α ( U ( n ) - U ( k ) )\end{matrix}}{P ( {C}_{n} \vert n )} \qquad ( Formula 14 )$$

If the next-best option is not showing any advertisements, then this expression simplifies to:

$${CPC}_{n} = \frac{α U ( n ) - {\sum }_{i = 1}^{n - 1} P ( {C}_{i} \vert n ) {CPC}_{i}}{P ( {C}_{n} \vert n )} \qquad ( Formula 15 )$$

The reserve price component 232 then selects as the minimum reserve price for the last advertisement in the given advertisement block to be the maximum of: 1) the minimum reserve price fixed by the publisher (e.g., five cents); 2) the CPC that takes into account user cost (Formula 14); or 3) the CPC of the advertisement ranked directly below the last advertisement in the given advertisement block. Note that although the advertisement ranked directly below the last advertisement in the block is not actually presented to the user, it is still utilized to provide price support.

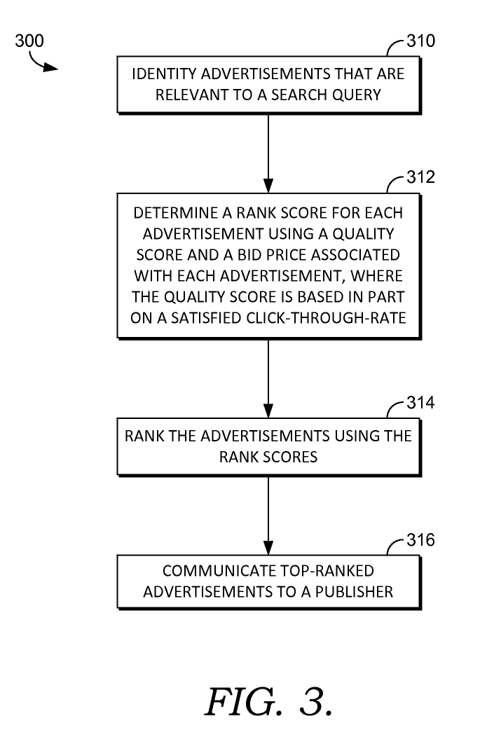

Turning now to FIG. 3, a flow diagram is depicted on an exemplary method 300 of ranking advertisements that are presented on a results page using quality weighting in a generalized second price auction. At a step 310, a set of advertisements is identified as relevant to either an implicit or an explicit search query. The search query may be provided by a publisher such as the publisher 214 of FIG. 2. This step may be carried out by a communication component such as the communication component 224 of the advertisement management service 210 shown in FIG. 2. The identified advertisements may include exact match advertisements and/or broad match advertisements.

At a step 312, a ranking component, such as the ranking component 226 of FIG. 2, determines a rank score for each advertisement in the set. The rank score is determined based on a quality score associated with the given advertisement and a bid price of the given advertisement and is generated by multiplying the quality score and the bid price. The quality score ranges between zero and one and provides an indication of the proportion of users whose needs were met by the advertisement and its associated landing page(s). Because it is difficult to directly measure whether a user's needs were met by a given advertisement, the ranking component utilizes one or more proxy metrics as indicators of met need. One proxy metric includes the satisfied click-through-rate for the advertisement. As explained above, a satisfied click is recorded every time a user selects the advertisement and spends a predetermined amount of time dwelling on the advertisement's landing page(s). Exemplary dwelling times include 20 seconds or greater, 30 seconds or greater, and the like. Another proxy metric may include the proportion of users who access a secure page after selecting the advertisement. This information is gathered by analyzing the URL stream associated with the user(s) and/or examining characteristics of Web pages accessed by the user after selecting the advertisement. Conversion rates associated with a selected advertisement may also be used as a proxy metric along with whether the selection of the advertisement terminated the current search session (i.e., whether the selection of the advertisement constituted a “last click” ending the current search session).

At a step 314, the ranking component ranks the advertisements within the set based on their respective rank scores. Advertisements are ranked in descending order (e.g., highest-ranked to lowest-ranked). At a step 316, a plurality of top-ranked advertisements is communicated to the publisher. The publisher subsequently presents in ranked order the plurality of advertisements on a results page such as, for example, a search results page.

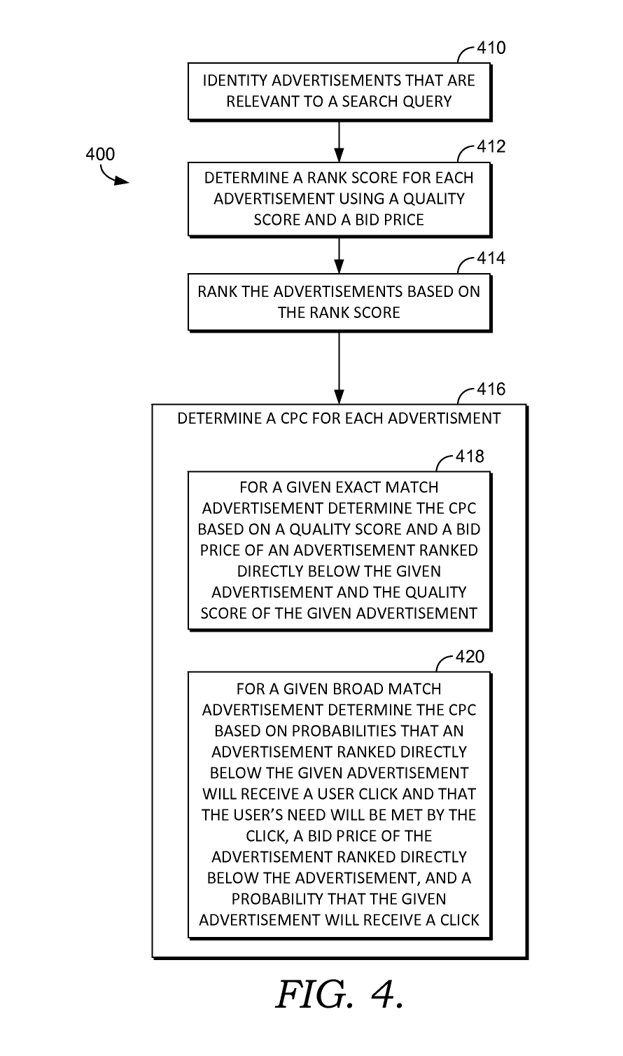

FIG. 4 depicts an exemplary method 400 of ranking and pricing advertisements that are presented on a results page using quality weighting in a generalized second-price auction. At a step 410, a set of advertisements is identified as relevant to a search query. The advertisements in the set include both exact match advertisements and broad match advertisements. At a step 412, a rank score is determined for each of the advertisements in the set. Like the method 300, the rank score is determined based on each advertisement's quality score and its bid price. The advertisement's satisfied click-through-rate is used as a proxy metric for the quality score. At a step 414, the advertisements in the set are ranked based their respective rank scores.

At a step 416, a pricing component, such as the pricing component 228 of FIG. 2, determines a CPC for each of the advertisements in the set. As shown at step 418, if the advertisement is an exact match advertisement, the pricing component determines the CPC based on a quality score of an advertisement ranked directly below the exact match advertisement, a bid price of the advertisement ranked directly below the exact match advertisement, and the quality score of the exact match advertisement. The relationship between these different variables in shown in Formula 2 above.

As shown at step 420, when the advertisement is a broad match advertisement, the pricing component determines its CPC based on a probability that an advertisement ranked directly below the broad match advertisement will receive a click or selection, a probability that a user's need is met given there is a click on the advertisement ranked directly below the broad match advertisement (using satisfied click-through-rate as a proxy metric), a bid price of the advertisement ranked directly below the broad match advertisement, and a probability that the broad match advertisement will receive a click. The relationship between these variables is shown in Formula 3 above.

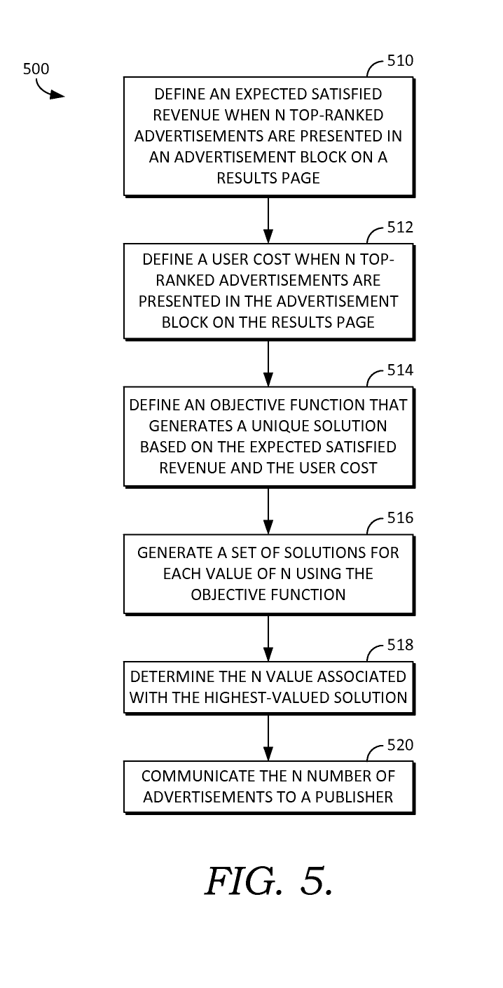

FIG. 5 depicts a flow diagram of an exemplary method 500 of determining a number of advertisements to be presented in an advertisement block on a results page. At a step 510, an allocation component, such as the allocation component 230 of FIG. 2, defines an expected satisfied revenue when n top-ranked advertisements are presented in the advertisement block. Expected satisfied revenue is revenue generated when a user selects an advertisement in the advertisement block and spends a predetermined amount of time on the advertisement's landing page(s).

At a step 512, the allocation component defines a user cost when the n top-ranked advertisements are presented in the advertisement block. User cost may be defined in terms of the space consumed by the top n advertisements on the results page as shown by Formula 5 above. As well, the user cost may be defined in both space terms and win rate as shown by Formula 6 above. The win rate is defined as the probability that the advertisement block will receive a satisfied click versus the probability that the results page as a whole will receive a satisfied click as shown by Formula 7.

At a step 514, the allocation component defines an objective function that generates a unique solution based on the expected satisfied revenue and the user cost for each n top-ranked advertisement. This objective function is shown in Formula 11. At a step 516, the allocation component utilizes the objective function to generate a set of solutions for each value of n. The allocation component, at a step 518, determines the n value associated with the highest-valued solution of the set of solutions (i.e., the n value that maximizes the objective function). This n value is equal to the number of advertisements that will be presented in the advertisement block and represents the maximization of expected satisfied revenue and the minimization of user cost. At a step 520, the determined number of advertisements is communicated to a publisher where they are subsequently presented on a results page.

The method 500 may further comprise determining a minimum reserve price for the lowest-ranked advertisement in the advertisement block; this determination may be carried out by a reserve price component, such as the reserve price component 232 of FIG. 2. The minimum reserve price comprises a maximum of either a predetermined minimum reserve price set by the publisher, a minimum reserve price based on the cost to the user, or a bid price of an advertisement ranked directly below the lowest-ranked advertisement in the advertisement block. Formula 14 above is utilized by the reserve price component to determine the reserve price based on the cost to the user. Formula 14 determines the user cost generally by equating the objective function that utilizes the n value equal to the number of advertisement presented in the advertisement block to the objective function that utilizes a k value equal to a number of advertisements that generates the next-highest-valued solution.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed, perform a method of ranking advertisements that are presented on a results page using quality weighting in a generalized second-price auction, the method comprising:
identifying a set of advertisements that is relevant to a search query;
determining a rank score for each advertisement in the set of advertisements, the rank score determined based on a quality score of the each advertisement and a bid price of the each advertisement, wherein the quality score is based in part on a satisfied click-through-rate for the each advertisement;
ranking the set of advertisements based on the rank scores; and
communicating a plurality of top-ranked advertisements of the set of advertisements to a publisher who presents in ranked order the plurality of top-ranked advertisements on the results page.

2. The media of claim 1, wherein the set of advertisements includes advertisements that are exact matches to the search query and advertisements that are broad matches to the search query.

3. The media of claim 1, wherein the rank score is determined using the following formula:
Rank Scoreᵢ=qᵢ*bᵢ
where Rank Score, is the rank score for the i^{th} advertisement,
qᵢ is the quality score for the i^{th} advertisement, and
bᵢ is the bid price of the i^{th} advertisement.

4. The media of claim 1, wherein the quality score of the each advertisement comprises a value between 0 and 1, and wherein the quality score provides an indication of a proportion of users whose needs are met by the each advertisement and the each advertisement's associated landing page(s).

5. The media of claim 1, wherein the satisfied click-through-rate comprises a proportion of users who selected the each advertisement and dwelled on the each advertisement's associated landing page for a predetermined period of time.

6. The media of claim 5, wherein the predetermined period of time is 20 seconds or greater.

7. The media of claim 5, wherein the predetermined period of time is 30 seconds or greater.

8. The media of claim 1, wherein the quality score of the each advertisement is further based in part on one or more of the following:
a proportion of users who access a secure page after selecting the each advertisement,
a proportion of users who terminate an ongoing search session after selecting the each advertisement, or
a proportion of users who make a purchase after selecting the each advertisement.

9. The media of claim 1, wherein the results page comprises a search engine results page.

10. One or more computer-storage media having computer-executable instructions embodied thereon that, when executed, perform a method of ranking and pricing advertisements that are presented on a results page using quality weighting in a generalized second-price auction, the method comprising:
identifying a set of advertisements that is relevant to a search query;
determining a rank score for each advertisement in the set of advertisements, the rank score determined based on a quality score of the each advertisement and a bid price of the each advertisement, wherein the quality score is based in part on a satisfied click-through-rate for the each advertisement;
ranking the set of advertisements based on the rank scores; and
determining a cost-per-click (CPC) for the each advertisement in the set of advertisements, wherein for a given advertisement in the set of advertisements:
when the given advertisement is an exact match to the search query, determining the CPC based on a quality score of an advertisement ranked directly below the given advertisement, a bid price of the advertisement ranked directly below the given advertisement, and a quality score of the given advertisement, and
when the given advertisement is a broad match to the search query, determining the CPC based on a probability that an advertisement ranked directly below the given advertisement will receive a click, a probability that a user's need is met given there is a click on the advertisement ranked directly below the given advertisement, a bid price of the advertisement ranked directly below the given advertisement, and a probability that the given advertisement will receive a click.

11. The media of claim 10, wherein determining the CPC for the given advertisement that is the exact match to the search query comprises using the following formula:
$${CPC}_{i} = \frac{{q}_{i + 1} {b}_{i + 1}}{{q}_{i}}$$
where CPC, is the cost-per-click of the given advertisement,
qᵢ₊₁ is the quality score of the advertisement ranked directly below the given advertisement,
bᵢ₊₁ is the bid price of the advertisement ranked directly below the given advertisement, and
qᵢ is the quality score of the given advertisement.

12. The media of claim 10, wherein determining the CPC for the given advertisement that is the broad match to the search query comprises using the following formula:
$$CPCi = \frac{p ( {c}_{i + 1} ) p ( {n}_{i + 1} \vert {c}_{i + 1} ) {b}_{i + 1}}{p ( {c}_{i} )}$$
where CPCᵢ is the cost-per-click for the given advertisement,
p(cᵢ₊₁) is the probability of the click on the advertisement that is ranked directly below the given advertisement,
p(nᵢ₊₁|cᵢ₊₁) is the probability that the user's need is met given there is the click on the advertisement that is ranked directly below the given advertisement,
bᵢ₊₁ is the bid price of the advertisement that is ranked directly below the given advertisement, and
p(cᵢ) is the probability that the given advertisement will receive a click.

13. One or more computer-storage media having computer-executable instructions embodied thereon that, when executed, perform a method of determining a number of advertisements to be presented in an advertisement block on a results page in a generalized second-price auction, the method comprising:
defining an expected satisfied revenue when n top-ranked advertisements are presented in the advertisement block;
defining a user cost when n top-ranked advertisements are presented in the advertisement block;
defining an objective function that generates a solution based on the expected satisfied revenue and the user cost for each n top-ranked advertisements in the advertisement block;
for each value of n, using the objective function to generate a solution;
determining the n value associated with the solution having the highest value, wherein the n value associated with the solution having the highest value is equal to the number of advertisements to be presented in the advertisement block on the results page such that expect satisfied revenue is maximized and user cost is minimized; and
communicating the determined number of advertisements to a publisher who presents the determined number of advertisements in the advertisement block on the results page.

14. The media of claim 13, wherein the expected satisfied revenue is based in part on a satisfied click-through-rate for each of the n top-ranked advertisements.

15. The media of claim 13, wherein the user cost is based on vertical space on a results page that is occupied by the n top-ranked advertisements.

16. The media of claim 15, wherein the user cost is further based on a probability of a satisfied click on the n top-ranked advertisements compared to a probability of a satisfied click on the results page as a whole.

17. The media of claim 16, wherein the user cost is inversely proportional to the probability of the satisfied click on the n top-ranked advertisements compared to the probability of the satisfied click on the results page as a whole.

18. The media of claim 13, further comprising:
subsequent to determining the number of advertisements to be presented in the advertisement block, determining a minimum reserve price for the lowest-ranked advertisement that is presented in the advertisement block, wherein the minimum reserve price comprises a maximum of the following:
a predetermined minimum reserve price,
a reserve price based in part on the user cost, or
a bid price of an advertisement that is ranked directly below the lowest-ranked advertisement that is presented on the results page.

19. The media of claim 18, wherein the reserve price based in part on the user cost is generated by equating the objective function that utilizes the n value equal to the number of advertisement presented in the advertisement block to an objective function that utilizes a k value equal to a number of advertisements that generates the next-highest-valued solution.

20. The media of claim 18, wherein the predetermined minimum reserve price is set by the publisher.
